(19) United States
(12) Patent Application Publication
(10) Pub. No.: US 2015/0089908 A1
(43) Pub. Date: Apr. 2, 2015

(54) MODULAR TRASH SCREEN COMPONENT FOR AIR INLET DUCT OF TURBINE SYSTEM

(71) Applicant: Braden Manufacturing, LLC, Tulsa, OK (US)

(72) Inventors: Lawrence A. Kenny, III, Rindge, NH (US); Brian S. Nason, Phillipston, MA (US)

(73) Assignee: Braden Manufacturing, LLC, Tulsa, OK (US)

(21) Appl. No.: 14/043,515

(22) Filed: Oct. 1, 2013

(51) Int. Cl. B01D 46/00

(52) U.S. Cl. CPC B01D 46/002; B01D 46/0005
USPC 55/483; 55/495; 55/511; 29/428

(57) ABSTRACT

A modular trash screen component includes a support frame and a wire screen secured to the support frame. The support frame encloses and defines a central opening. The support frame has interior and exterior surfaces, a base portion, and a peripheral portion extending outward from the base portion. The wire screen has a base portion generally coextensive with the central opening of the support frame, and a peripheral portion extending outward from the base portion of the wire screen. The wire screen is nested in the support frame such that outer edge margins of the base portion of the wire screen are in generally opposing relationship with the interior surface of the base portion of the support frame, and the peripheral portion of the wire screen is in generally opposing relationship with the interior surface of the peripheral portion of the support frame.

### FIELD OF THE DISCLOSURE

The present invention generally relates to a modular trash screen component for an air inlet duct of a turbine system, an air inlet duct including a trash screen assembly including a plurality of the trash screen components, and a method of assembling a trash screen assembly using a plurality of the modular trash screen components.

### BACKGROUND OF THE DISCLOSURE

A turbine system typically includes an air inlet section for delivering intake air to a turbine, such as a gas turbine. The air inlet section typically has large ducting defining an enclosed flow path for air to flow to the turbine. Large pieces of debris (e.g., trash) can find its way into the ducting and become entrained in the air flow being delivered to the turbine. If debris enters the intake of the turbine, it can cause substantial damage. To inhibit large pieces of debris from making its way to the intake of the turbine, the air inlet section may include a trash screen assembly that allows the flow of air therethrough while inhibiting the pieces of debris from entering the turbine.

A typical conventional trash screen assembly includes upper and lower sections. Each section includes a rectangular support frame including vertical braces welded to the interior of the air inlet duct. A wire screen (e.g., sections of wire screen) is laid over a front or upstream face of the support frame. Flat bars are laid over the wire screen and welded to the support frame.

### SUMMARY OF THE DISCLOSURE

In one aspect, a modular trash screen component for an air inlet duct of a turbine system generally comprises a support frame and a wire screen secured to the support frame. The support frame encloses and defines a central opening of the support frame. The support frame has interior and exterior surfaces, a base portion, and a peripheral portion extending outward from the base portion. A wire screen is secured to the support frame. The wire screen has a base portion generally coextensive with the central opening of the support frame, and a peripheral portion extending outward from the base portion of the wire screen. The wire screen is nested in the support frame such that outer edge margins of the base portion of the wire screen are in generally opposing relationship with the interior surface of the base portion of the support frame, and the peripheral portion of the wire screen is in generally opposing relationship with the interior surface of the peripheral portion of the support frame.

In another aspect, a method of assembling a trash screen assembly in an inlet duct for a turbine system generally comprises providing a plurality of modular trash screen components, wherein each modular trash screen component includes a support frame enclosing and defining a central opening of the support frame, the support frame having interior and exterior surfaces, a base portion, and a peripheral portion extending outward from the base portion; and a wire screen secured to the support frame, the wire screen having a base portion generally coextensive with the central opening of the support frame, and a peripheral portion extending outward from the base portion of the wire screen, wherein the wire screen is nested in the support frame such that an outer edge margin of the base portion of the wire screen is in generally opposing relationship with the interior surface of the base portion of the support frame, and the peripheral portion of the wire screen is in generally opposing relationship with the interior surface of the peripheral portion of the support frame. The modular trash screen components are secured to the air inlet duct so that the modular trash screen components are arranged side-by-side in the air inlet duct.

In yet another aspect, an air inlet duct assembly generally comprises an air inlet duct for air inlet ducting of a turbine system. The air inlet duct includes upper, lower, left, and right side walls defining and enclosing an air passage having an inlet opening, an outlet opening, and a flow path extending between the inlet and outlet openings. A plurality of modular trash screen components are secured to the air inlet duct and arranged side-by-side within the air passage so that the modular trash screen components span horizontally across the air passage. Each modular trash screen component includes a generally rectangular support frame enclosing and defining a central opening of the support frame. The support frame has interior and exterior surfaces, a base portion, and a peripheral portion extending outward from the base portion. A generally rectangular wire screen is secured to the support frame. The wire screen has a base portion generally coextensive with the central opening of the support frame, and a peripheral portion extending outward from the base portion of the wire screen. The wire screen is nested in the support frame such that an outer edge margin of the base portion of the wire screen is in generally opposing relationship with the interior surface of the base portion of the support frame, and the peripheral portion of the wire screen is in generally opposing relationship with the interior surface of the peripheral portion of the support frame.

### BRIEF DESCRIPTION OF THE DRAWINGS

FIG. 1 is a schematic of an exemplary turbine system;

FIG. 2 is a perspective of an air inlet duct of the turbine system, including a trash screen assembly secured therein;

FIG. 3 is a perspective of a cross section of the air inlet duct, with some modular trash screen components of the trash screen assembly removed therefrom;

FIG. 4 is a front perspective of one modular trash screen component of the trash screen assembly;

FIG. 5 is a rear perspective of the modular trash screen component;

FIG. 6 is an exploded view of the trash screen component;

FIG. 7 is a perspective of a support frame of the trash screen component;

FIG. 8 is an enlarged, fragmentary perspective of a wire screen of the trash screen component, illustrating a corner of the wire screen;

FIG. 9 is an enlarged, fragmentary perspective of the trash screen component, illustrating a corner of the trash screen component; and

FIG. 10 is a fragmentary cross section of the trash screen component taken through a plane defined by the line 10--10 in FIG. 5.

Corresponding reference characters indicate corresponding parts throughout the drawings.

### DETAILED DESCRIPTION OF THE DRAWINGS

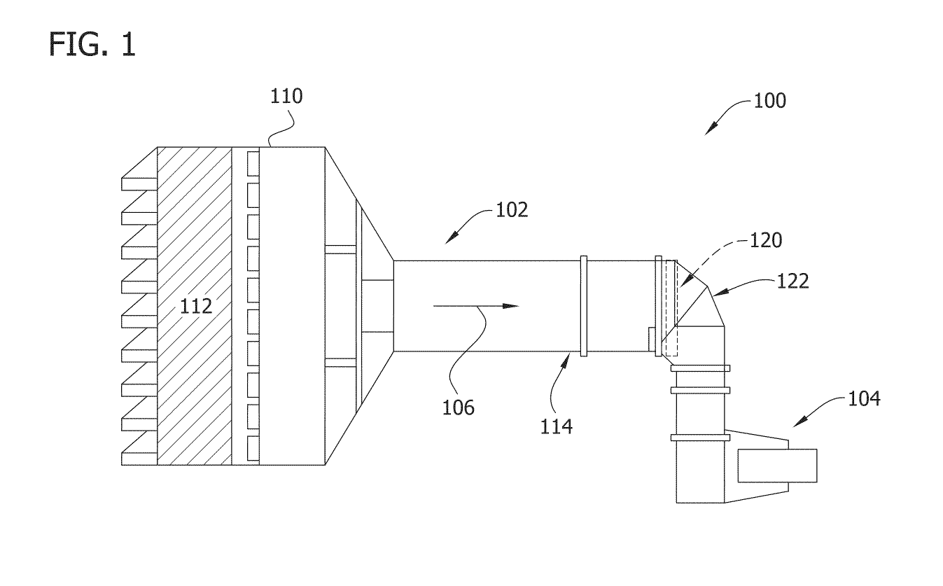

Referring now to the drawings, and in particular to FIG. 1, an exemplary embodiment of a turbine system (e.g., a gas turbine system) is generally indicated at 100. The turbine system 100 includes an air inlet section, generally indicated at 102, a turbine section, generally indicated at 104, and an exhaust section (not shown). The turbine section 104 receives airflow 106 from the air inlet section 102, as is generally known in the art. The air inlet section 102 comprises a filter house 110, including a plurality of air filters 112 disposed therein, and air inlet ducting, generally indicated at 114, fluidly connecting the filter house to the turbine section 104 for delivering filtered intake air to the turbine section. As explained in detail hereinafter, a trash screen assembly, generally indicated at 120, is provided within the air inlet ducting 114 for inhibiting debris (e.g., trash) within the air inlet ducting from entering the turbine section 104.

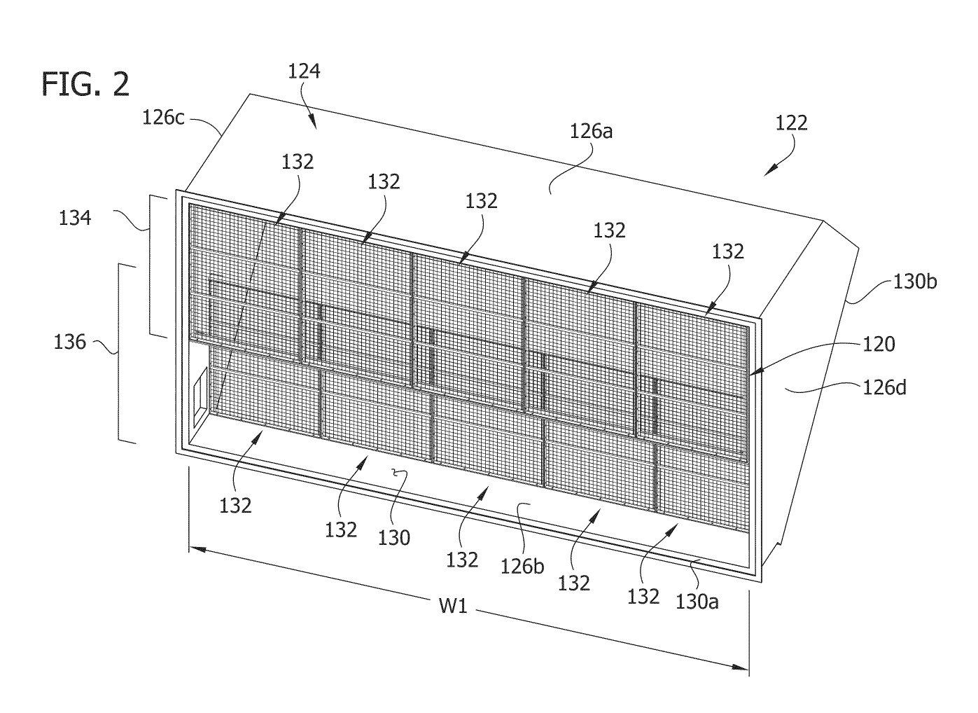

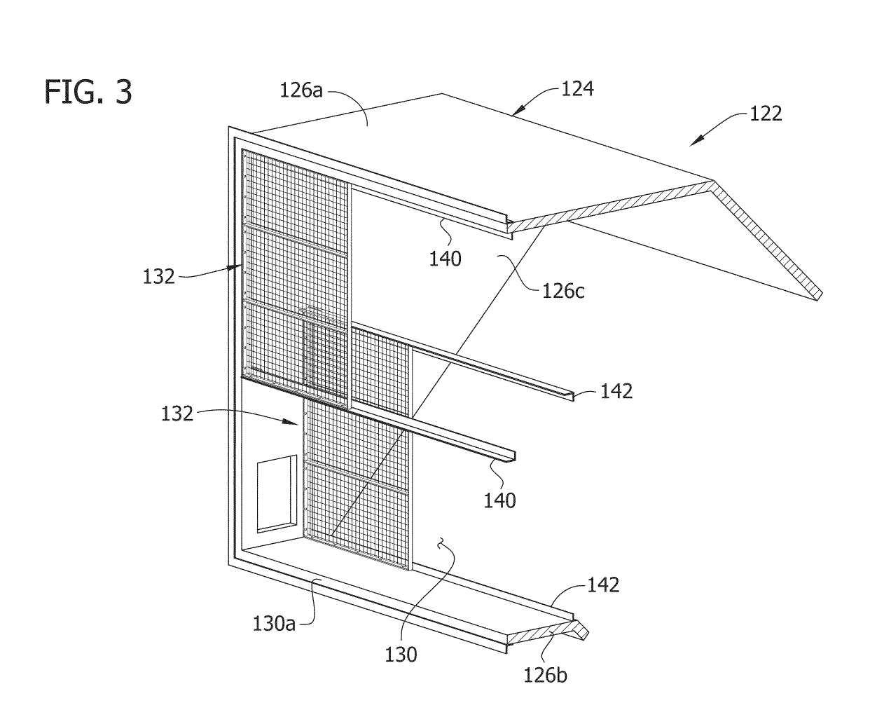

Referring to FIGS. 2 and 3, in the illustrated embodiment the trash screen assembly 120 is secured within a section or air inlet duct, generally indicated at 122 (see also, FIG. 1), of the air inlet ducting 114. The air inlet duct 122 includes a duct housing, generally indicated at 124, and the trash screen assembly 120 (FIG. 2) secured within the duct housing. The duct housing 124 includes upper, lower, left, and right side walls 126a, 126b, 126c, 126d, respectively. The walls 126a-d define and enclose an air passage 130 having an inlet opening 130a, an outlet opening 130b, and a flow path for the air flow 106 extending between the inlet and outlet openings. The trash screen assembly 120 includes a plurality of modular trash screen components, each generally indicated at 132, constructed in accordance with teachings of the present disclosure. In the illustrated embodiment, the trash screen components 132 are provided in upper and lower sets 134, 136, respectively (FIG. 2), where the upper set is upstream of the lower set. Each set 134, 136 includes a plurality of the trash screen components 132 arranged side-by-side in the duct housing 124 so that together the trash screen components of the respective upper and lower sets 134, 136 span an inner horizontal dimension W1 (e.g., the inner width) extending between the left and right side walls 126c, 126d, respectively, of the duct housing 124. As shown in FIG. 3 and explained in more detail below when discussing an exemplary method of assembling the trash screen assembly 120, the trash screen components 132 are secured (e.g., welded) to upper and lower flanges 140, 142, respectively, within the duct housing 124.

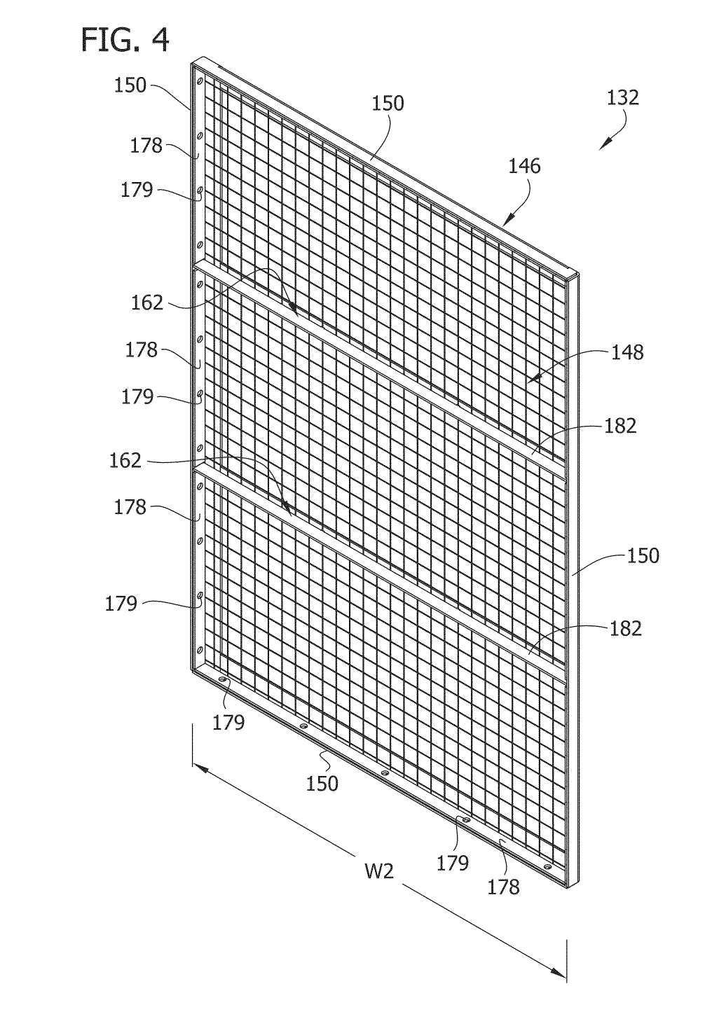

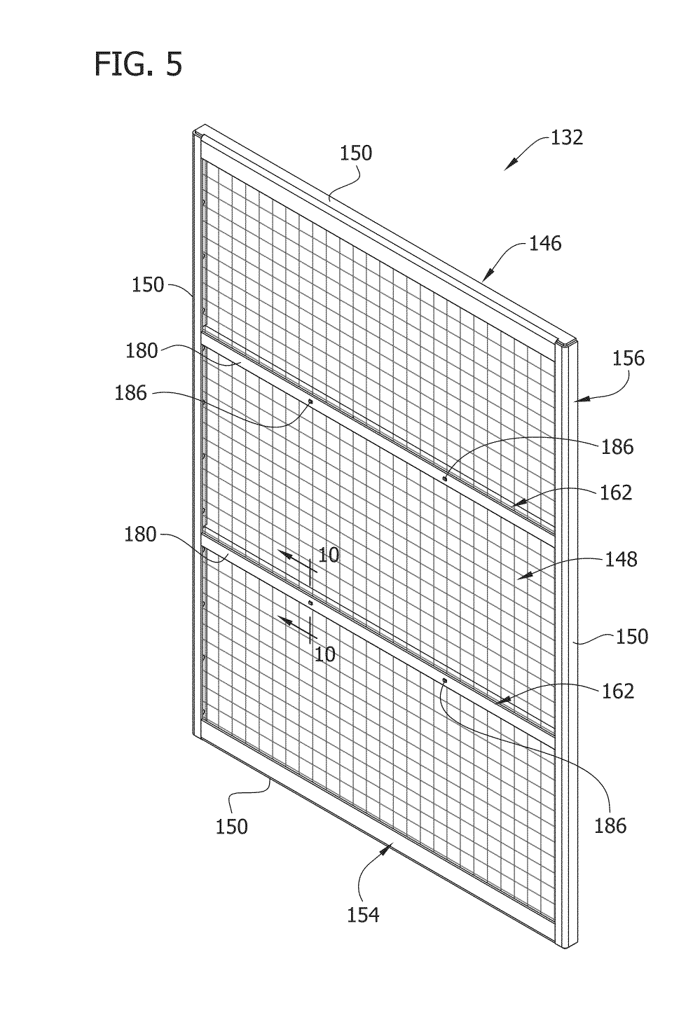

Referring to FIGS. 4 and 5, each modular trash screen component 132 comprises a rectangular support frame, generally indicated at 146, and a rectangular wire screen, generally indicated at 148, secured to the support frame. In one embodiment, the modular trash screen components 132 are essentially identical in structure and dimensions, although it is contemplated that in some applications, one or more of the components may have dimensions and/or structure different than the other trash screen components. For purposes of this disclosure, only one modular trash screen component 132 is described in detail, with the understanding that the following disclosure relates equally to all of the trash screen components 132 of the trash screen assembly 120.

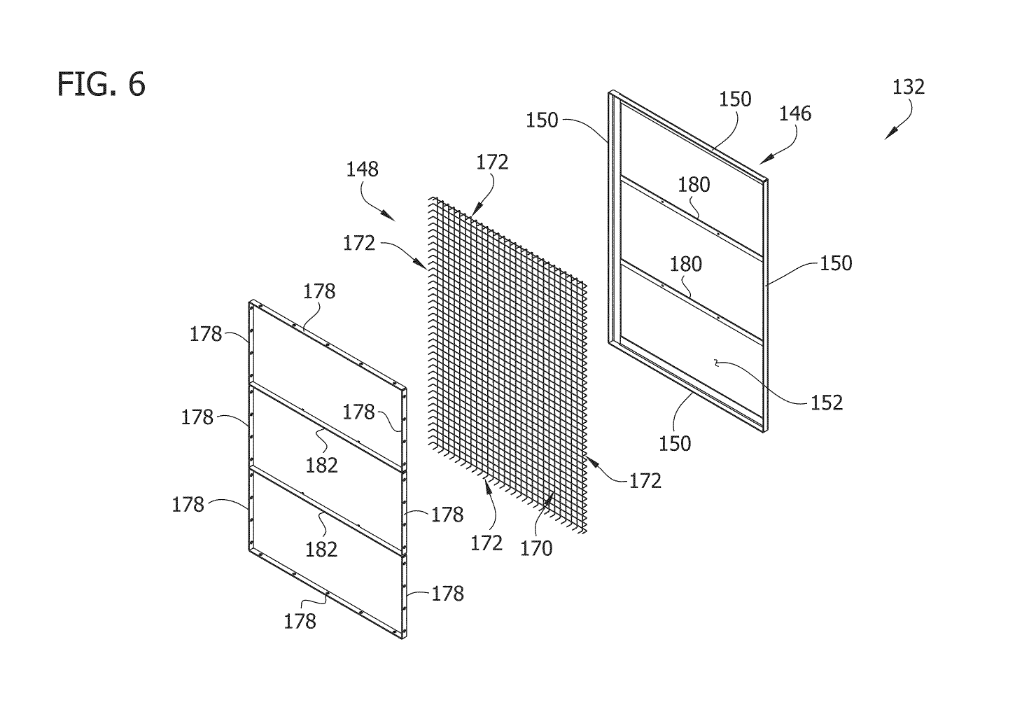

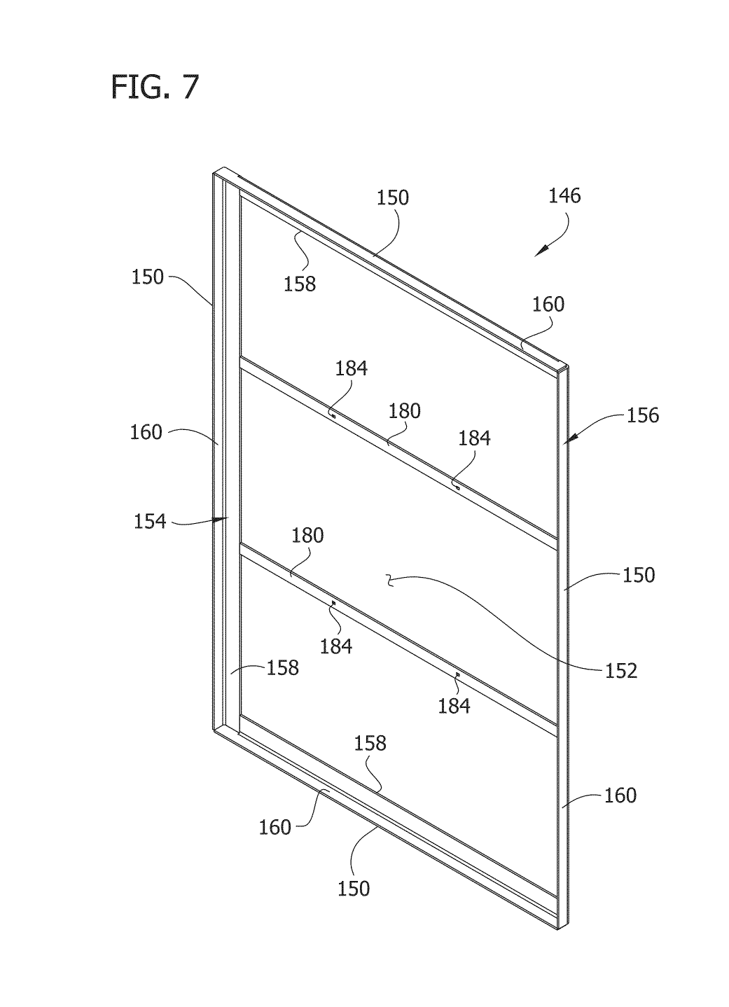

As seen best in FIG. 6, the support frame 146 is generally rectangular and encloses and defines a central opening 152. As seen best in FIGS. 5 and 7, the support frame 146 has interior and exterior surfaces; a base portion, generally indicated at 154, defining a rear or downstream side of the support frame in the illustrated embodiment; and a peripheral or flange portion, generally indicated at 156, extending forward (i.e., outward) from the base portion and defining sides of the support frame. In the illustrated embodiment, the support frame 146 includes four elongate support members 150 (i.e., upper, lower, left and right support members), secured to one another at their respective ends and enclosing and defining the central opening 152. The support members 150 are generally L-shaped in cross section and include rear portions (the rear portion of the right support member is not visible in FIG. 6) defining the base portion 154 of the support frame 146, and side portions extending forward from the rear portions and defining the peripheral portion 156 of the support frame. In the illustrated embodiment, when the trash screen components 132 are secured within the air inlet ducting 114 of the inlet section 102, the base portion 154 of the support frame is 146 downstream of the peripheral portion 156 (i.e., the peripheral portion extends upstream). It is understood that the trash screen components 132 may be secured in the inlet air ducting 114 such that the base portion 154 of the support frame 146 is upstream of the peripheral portion 156 (i.e., the peripheral portion extends downstream). The support members 150 may comprise angle irons having L-shaped cross sections constructed from metal, such as stainless steel, or other generally rigid material. To provide additional rigidity to the support frame 146, at least one elongate brace, generally indicated at 162, is secured to opposite support members 150 and spans the central opening 152 of the support frame 146. For example, in the illustrated embodiment two elongate braces 162 extend horizontally across the central opening 152 between the left and right support members 150.

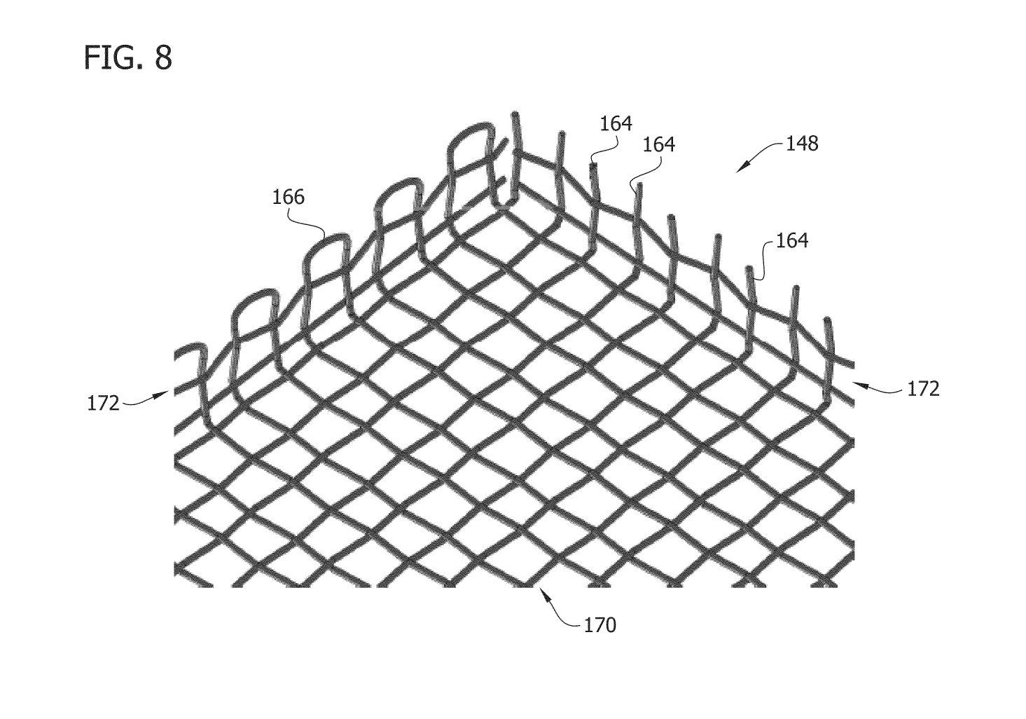

Referring to FIG. 8, in the illustrated embodiment, the wire screen 148 comprises woven wire mesh (e.g., stainless steel wire or other metal wire), including warp wires 164 and a continuous weft wire 166 extending generally transverse to and interwoven with the warp wires. It is understood that the wire screen 148 may be of other configurations, including a welded screen, without departing from the scope of the present invention. As also shown in FIG. 6, the wire screen 148 has a central base portion, generally indicated at 170, generally coextensive with the central opening 152 of the support frame 146, and a peripheral portion, generally indicated at 172, extending forward (e.g., upstream) from outer edge margins of the base portion to define four sides of the wire screen (i.e., upper, lower, left and right sides). The wire screen 148 is nested in the support frame 146 such that outer edge margins of the base portion 170 of the wire screen are in generally opposing relationship with the interior surface of the base portion 154 of the support frame 146, and each peripheral portion 172 of the wire screen is in generally opposing relationship with the interior surface of the peripheral portion 156 of the support frame.

Referring to FIGS. 4, 5, and 9, the wire screen 148 is secured to the support frame 146 by way of at least one clamping member 178 secured to the interior surface of the support frame. In particular, at least one of the peripheral portion 172 of the wire screen 148 and the outer edge margins of the base portion 170 of the wire screen is clamped between a plurality of clamping members 178 and the support frame 146 for securing the wire screen to the support frame. In the illustrated embodiment, the clamping members 178 are secured to the peripheral portion 156 of the support frame 146 and both the peripheral portion 172 of the wire screen 148 and the outer edge margins of the base portion 170 of the wire screen are clamped between the clamping members and the support frame. In the illustrated embodiment, each clamping member 178 includes a metal flat bar in opposing relationship and extending along the respective interior surface of the peripheral portion 156 of the support frame 146. As illustrated, the clamping members 178 are secured to the support frame 146 at a plurality of spot welds, the locations of which are indicated at reference numeral 179. It is understood that the clamping members 178 may be formed as a single, one-piece member or a plurality of separate members, as illustrated. The wire screen 148 may be secured to the support frame 146 in other ways without departing from the broad scope of the present disclosure.

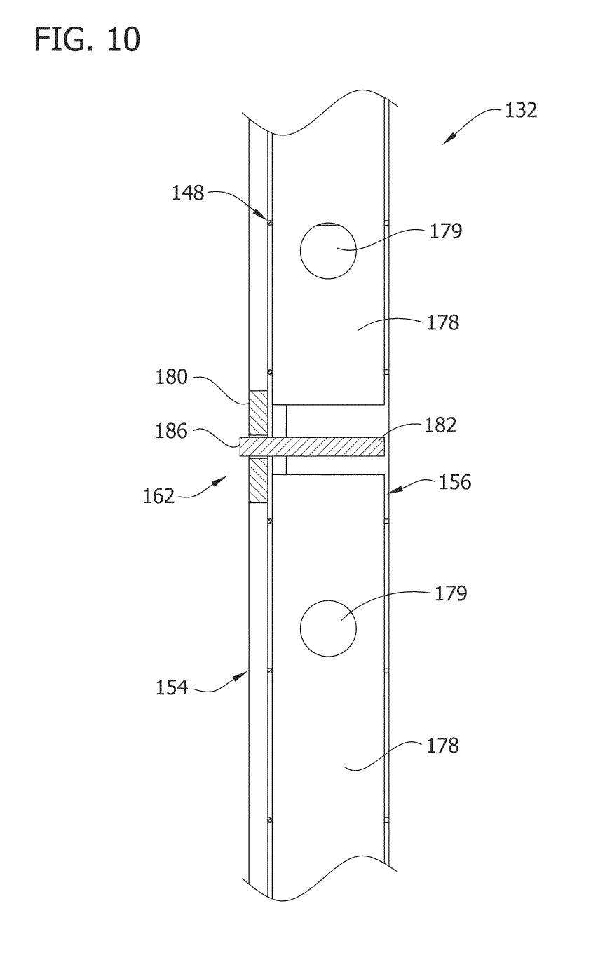

Referring to FIG. 10, the wire screen 148 is also secured to the braces 162. In the illustrated embodiment, each brace 162 is generally T-shaped in a transverse cross section and includes a base portion 180 (e.g., a downstream portion) and a center stem portion 182 extending forward from generally a center axis of the base portion. The base portion 180 of the brace 162 has openings 184 (see also FIG. 7) spaced apart generally along its center axis. The stem portion 182 has extensions 186 extending through the openings 184 in the base portion 180. The extensions 186 are secured (e.g., welded) to the base portion 180. The wire screen 148 is clamped between the base and stem portions 180, 182, respectively, of the brace 162 for securing the wire screen to the brace (see also FIG. 6). The wire screen 148 may be secured to the brace 162 in other ways without departing from the broad scope of the present disclosure.

An exemplary method of forming each of the modular trash screen components 132 and assembling the trash screen assembly 120 within the air inlet duct will now be described. In one embodiment, the desired horizontal dimensions W2 (e.g., widths) of the trash screen components are based, at least in part, on the inner horizontal dimension W1 of the air inlet duct 122. In one example, the number and horizontal dimensions W2 of trash screen components 132 used in each trash screen component set 134, 136 are determined by dividing the inner horizontal dimension W1 of the air inlet duct 122 into equal dimensions (e.g., two to six or more equal dimensions). Thus, each of the trash screen components 132 will have generally the same horizontal dimension W2 so that together the trash screen components span substantially the entire inner horizontal dimension of the air inlet duct. For example, in the illustrated embodiment each trash screen component set 134, 136 includes five trash screen components 132 having substantially identical horizontal dimensions W2.

In one example, the support frame 146 of each trash screen component 132 is constructed by welding together four angle irons (broadly, the support members) having dimensions suitable for forming the trash screen component of desired dimensions. For example, the iron angles may be laser-cut, 3/16″ stainless steel plate. The cross section of the support frame 146, as determined by the iron angles, can be chosen based, in part, on local strength requirements. The base portions 180 of the two braces 162, as in the illustrated embodiment, are welded to the interior surfaces of the opposite left and right angle irons 150 at locations that are ⅓ of the horizontal dimension W3 of the central opening 152 so that the braces divide the central opening into three equal sections. The base portions 180 of the braces 162 may include flat bars formed from 3/16″ stainless steel plate.

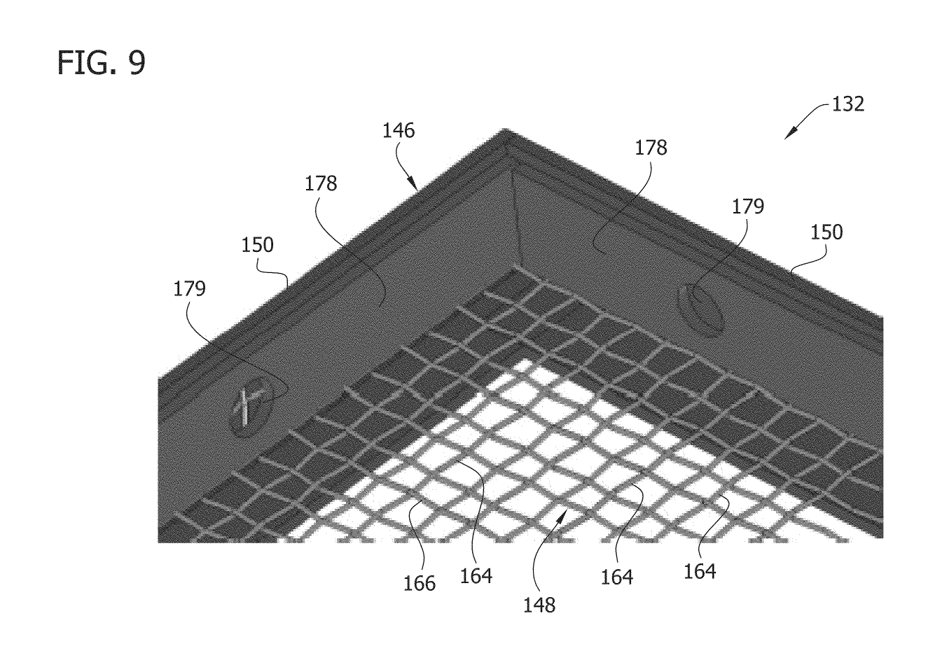

In one example, the rectangular wire screen 148 is formed from the continuous sinuous weft wire 166 extending generally transverse to and interwoven with the warp wires 164, as disclosed above. The peripheral portion 172 of the wire screen 148 is formed by bending the side edge margins of the screen forward. As shown in FIG. 9, the dimension of the screen 148 spanning the opposite edges defined by the weft wire 166 may be chosen so that when the screen is nested in the support frame 146 the edges are substantially coextensive with or do not extend beyond the side portions 160. With respect to the other dimension spanning the opposite edges defined by the warp wires 164, this dimension may be chosen so that when the screen 148 is nested in the support frame 146 the respective ends of the warp wires extend beyond the respective side portions 160. The ends of the warp wires 164 may be cut to be substantially coextensive with the peripheral portion 156 of the support frame 146 after nesting the wire screen 148 in the frame. In an alternate embodiment, the warp wires 164 may be cut before nesting the wire screen 168 in the support frame 146.

With the wire screen 148 nested in the support frame 146, the upper, lower, left, and right clamping members 178 are plug welded to the interior surface of the peripheral portion 156 of the support frame 146 at the plug-welding locations 179. The peripheral portion 172 and the outer edge margins of the base portion 170 of the wire screen 148 are clamped between the respective clamping members 178 and the interior surface of the support frame 146. Each clamping member 178 may comprise a flat bar of stainless steel defining a plurality of openings at the plug-welding locations 179 for use in plug welding the clamping member to the support frame 146. With respect to the sides of the screen 148 defined by the warp wires 164, before plug welding the corresponding clamp member 178, portions of the weft wire 166 (or other wire extending transverse to the corresponding warp wires) adjacent the respective side edges defined by the warp wires may be removed, as shown in FIGS. 8 and 9. In particular, portions of the weft wire 166 (or other wires) that are not contained by the discrete plug welds at the locations 179 may be removed to inhibit loose, cut or broken fragments of the wire screen 148 from detaching from the trash screen component 132. With respect to the sides of the screen 148 defined by the weft wire 166, the warp wires 164 adjacent to the corresponding sides are not removed because these warp wires are trapped by the return of the weft wire at the corresponding side edges and cannot readily detach from the screen.

Next, the wire screen 148 is secured to the braces 162. The extensions 186 of the stem portion 182 of each brace 162 are inserted into the openings 184 in the corresponding base portion 180 of the brace. The extensions 186 are then welded to the base portion 180 of the brace 162. The wire screen 148 may be secured to the braces 162 in other ways.

When assembling the trash screen assembly 120, the upper and lower flanges 140, 142 (i.e., screen-attachment members) are provided (e.g., secured) in the air inlet duct 122. The upper and lower flanges 140, 142 span the inner horizontal dimension W1 of the air inlet duct 122 and provide a surface to which the trash screen components 132 are secured. In one example, the upper and lower trash screen component sets 134, 136, which are offset along the flow path, are assembled in the inlet air duct 122. In such an example, each trash screen component set 134, 136 is secured (e.g., welded) to respective upper and lower vertical flanges 140, 142 within the inlet air duct. At least some of the upper and lower vertical flanges 140, 142 may comprise angle irons secured the left and right side walls 126c, 126d of the inlet duct housing 124 and spanning horizontally across the air passage 130. A plurality of the trash screen components 132 are secured (e.g., welded) to respective ones of the upper and lower vertical flanges 140, 142 to form the sets 134 of trash screen components 132. The trash screen components 132 in the upper set 134 are arranged side-by-side and span substantially the entirety of the inner horizontal dimension W1 of the air inlet duct 122. A plurality of additional trash screen components 132 are secured (e.g., welded) to respective ones of the upper and lower vertical flanges 140, 142 to form the lower set 136 of trash screen components 132. The trash screen components 132 in the lower set 136 are arranged side-by-side and span substantially the entirety of the inner horizontal dimension W1 of the air inlet duct 122. When retrofitting an existing inlet duct 122, existing trash screen assemblies may include the upper and lower vertical flanges 140, 142 spanning the inner horizontal dimension W1 of the air inlet duct 122. The existing trash screen assemblies may be removed while retaining the upper and lower vertical flanges 140, 142.

As can be appreciated from the above disclosure, one or more of the following advantages may be obtained:

modular trash screen components can be built and easily assembled as trash screen assemblies within the inlet duct, improving the dimensional accuracy and fabrication time of the trash screen assemblies;

the modular trash screen components can be built off-site and easily assembled as trash screen assemblies for retro-fit applications;

all portions of the wire screen are trapped within the trash screen components, which lessen the likelihood of broken fragments of the screen detaching from the trash screen components;

the screen is clamped to the frame to provide a shear connection that resists the tensile loads along the full perimeter of the screen;

the clamping members stretch the screen across the central opening before the clamping members are secured to the support frame to provide a taut screen; and

the screen is held captive by the braces, which increases the pull-out resistance and overall strength of the modular components.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A modular trash screen component for an air inlet duct of a turbine system comprising:
a support frame enclosing and defining a central opening of the support frame, the support frame having interior and exterior surfaces, a base portion, and a peripheral portion extending outward from the base portion; and
a wire screen secured to the support frame, the wire screen having a base portion generally coextensive with the central opening of the support frame, and a peripheral portion extending outward from the base portion of the wire screen, wherein the wire screen is nested in the support frame such that outer edge margins of the base portion of the wire screen are in generally opposing relationship with the interior surface of the base portion of the support frame, and the peripheral portion of the wire screen is in generally opposing relationship with the interior surface of the peripheral portion of the support frame.

2. The modular trash screen component set forth in claim 1, further comprising at least one clamping member secured to the interior surface of the support frame, wherein at least one of the peripheral portion of the wire screen and the outer edge margins of the base portion of the wire screen are clamped between said at least one clamping member and the interior surface of the support frame for securing the wire screen to the support frame.

3. The modular trash screen component set forth in claim 2, wherein the clamping member comprises a plurality of clamping members secured to the interior surface of the peripheral portion of the support frame.

4. The modular trash screen component set forth in claim 3, wherein each of the peripheral portion of the wire screen and the outer edge margins of the base portion of the wire screen are clamped between the clamping members and the support frame for securing the wire screen to the support frame.

5. The modular trash screen component set forth in claim 4, wherein the clamping members are plug-welded to the interior surface of the peripheral portion of the support frame.

6. The modular trash screen component set forth in claim 1, further comprising at least one elongate brace spanning the central opening of the support frame, wherein the wire screen is secured to said at least one brace.

7. The modular trash screen component set forth in claim 6, wherein each of said at least brace is generally T-shaped in transverse cross section including a base portion and a center stem portion extending outward from the base portion, wherein the wire screen is clamped between the base and center stem portions of the brace for securing the wire screen to the brace.

8. The modular trash screen component set forth in claim 7, wherein the base portion of the brace has openings spaced apart generally along its center axis, and the center stem portion of the brace has extensions extending through the openings in the base portion of the brace for securing the center stem portion to the base portion of the brace.

9. The modular trash screen component set forth in claim 8, wherein the extensions of the center portion of the brace are welded to the base portion of the brace.

10. The modular trash screen component set forth in claim 1, in combination with an air inlet duct for a turbine system, wherein the modular trash screen component comprises a plurality of the modular trash screen components secured within the inlet duct and arranged side-by-side to form at least a portion of a trash screen assembly.

11. The modular trash screen component in combination with the air inlet duct set forth in claim 10, wherein the air inlet duct comprises upper and lower vertical flanges, wherein the plurality of module trash screen components are welded to the upper and lower vertical flanges.

12. A method of assembling a trash screen assembly in an inlet duct for a turbine system, the method comprising:
providing a plurality of modular trash screen components, wherein each modular trash screen component includes
a support frame enclosing and defining a central opening of the support frame, the support frame having interior and exterior surfaces, a base portion, and a peripheral portion extending outward from the base portion; and
a wire screen secured to the support frame, the wire screen having a base portion generally coextensive with the central opening of the support frame, and a peripheral portion extending outward from the base portion of the wire screen, wherein the wire screen is nested in the support frame such that an outer edge margin of the base portion of the wire screen is in generally opposing relationship with the interior surface of the base portion of the support frame, and the peripheral portion of the wire screen is in generally opposing relationship with the interior surface of the peripheral portion of the support frame; and
securing the modular trash screen components to the air inlet duct so that the modular trash screen components are arranged side-by-side in the air inlet duct.

13. The method set forth in claim 12, wherein the modular trash screen components are individually welded to the air inlet duct.

14. The method set forth in claim 13, wherein the modular trash screen components are welded to upper and lower vertical flanges in the air inlet duct.

15. Air inlet duct assembly comprising:
an air inlet duct for air inlet ducting of a turbine system, the air inlet duct including upper, lower, left, and right side walls defining and enclosing an air passage having an inlet opening, an outlet opening, and a flow path extending between the inlet and outlet openings,
a plurality of modular trash screen components secured to the air inlet duct and arranged side-by-side within the air passage so that the modular trash screen components span horizontally across the air passage, wherein each modular trash screen component includes
a generally rectangular support frame enclosing and defining a central opening of the support frame, the support frame having interior and exterior surfaces, a base portion, and a peripheral portion extending outward from the base portion; and
a generally rectangular wire screen secured to the support frame, the wire screen having a base portion generally coextensive with the central opening of the support frame, and a peripheral portion extending outward from the base portion of the wire screen, wherein the wire screen is nested in the support frame such that an outer edge margin of the base portion of the wire screen is in generally opposing relationship with the interior surface of the base portion of the support frame, and the peripheral portion of the wire screen is in generally opposing relationship with the interior surface of the peripheral portion of the support frame.

16. The air inlet duct assembly set forth in claim 15, wherein the air inlet duct further includes upper and lower vertical flanges within the air passage, wherein the plurality of modular trash screen components are secured to the upper and lower vertical flanges.

17. The air inlet duct set assembly forth in claim 15, wherein said plurality of modular trash screen components constitutes an upper set of the modular trash screen components, the air inlet duct assembly further comprising a lower set of the modular trash screen components, and wherein upper and lower sets of the modular trash screen components are spaced apart from one another along the flow path of the air passage.

18. The air inlet duct set assembly forth in claim 15, wherein each modular trash screen component further includes a clamping member secured to the interior surface of the support frame, wherein at least one of the peripheral portion of the wire screen and the outer edge margins of the base portion of the wire screen are clamped between the clamping member and the interior surface of the support frame for securing the wire screen to the support frame.

19. The air inlet duct set assembly forth in claim 18, wherein the clamping member is secured to the interior surface of the peripheral portion of the support frame.

20. The air inlet duct set assembly forth in claim 19, wherein each of the peripheral portion of the wire screen and the outer edge margins of the base portion of the wire screen are clamped between the clamping member and the support frame for securing the wire screen to the support frame.
